(19) United States
(12) Patent Application Publication
(10) Pub. No.: US 2003/0162885 A1
(43) Pub. Date: Aug. 28, 2003

(54) Glass resin ceramic composition and method of preparing the same

(76) Inventor: Duck-Ho Kim, Seoul (KR)

Correspondence Address: ABELMAN, FRAYNE & SCHWAB, 150 East 42nd Street, New York, NY, 10017-5612, US

(21) Appl. No.: 10/368,938

(22) Filed: Feb. 19, 2003

(30) Foreign Application Priority Data
Feb. 20, 2002 (KR) 2002-9120

(51) Int. Cl. C08L 1/00

(52) U.S. Cl. 524/494

(57) ABSTRACT

Disclosed is a glass resin ceramic (GRC) composition and method of producing the same. The GRC composition is based on a waste thermoplastic synthetic resin formulated with waste ceramic and/or waste glass. The GRC composition has higher tensile strength, bending strength and durability than do the conventional concrete compositions obtained from an admixture of flyash and slag. Also, the GRC composition shows high dimensional stability such that, when it is used to construct large-size products, uniform quality is guaranteed. Thanks to its high specific gravity, the GRC composition can be applied for the production of the products which need a considerable weight. Further, desired colors can be expressed in the composition. Reuse of waste ceramics and glass will give contribution to settlement of environmental pollution.

### BACKGROUND OF THE INVENTION

1. Field of the Invention

The present invention relates to a glass resin ceramic (hereinafter referred to simply as “GRC”) composition and a method of preparing the same. More particularly, the present invention relates to a GRC composition based on waste thermoplastic resin molten with waste ceramic and/or waste glass, superior in tensile strength, bending strength and durability to concrete compositions based on flyash and slag, and to a method of preparing GRC composition.

2. Description of the Prior Art

Generally, concrete is one of the construction materials that have been most widely used. It is considerably resistant to compression. Concrete, however, shows many disadvantages. For example, concrete is fairly vulnerable to chemicals and has low tensile and bending strength. When concrete is applied to form a shape, it looks ungainly. A mass of concrete is too heavy. Concrete is not suited where promptitude is required, because of its long period of curing time. Furthermore, construction of innumerous buildings has exhausted usable sand and pebbles from which conventional concrete is typically formulated. To solve the problems, there have been developed resin concrete compositions which are obtained by formulating synthetic resin mortar with cement plus sand and pebbles. However, the resin concrete compositions are economically unfavorable since the resins used, for example, unsaturated polyester resins, vinylether resins, polyurethane resins, phenol resins and epoxy resins, which are not of universal use, are highly expensive. Moreover, these thermosetting resins make it impossible to reuse the resin concrete compositions. In addition, the worldwide annual production amount of the thermosetting resins is not sufficient enough to apply for construction of general civil engineering structures.

Substitutes for conventional concrete can be found in patent documents.

Korean Pat. Publication No. 91-4357, issued to the present inventor, states a polymer ash slag (PAS) composition comprising high density polyethylene, low density polyethylene, and/or polypropylene, flyash, furnace slag, and an additive selected from among ferric oxide, carbon black, B.H.T. ronol and benzoyl peroxide, which shows higher tensile, bending and fracture strength than those of conventional concrete in addition to being superior in durability, weathering resistance and chemical resistance.

Sharp broken pieces of waste glass products, such as waste glass bottles from households and waste large-size glass pipes from construction spots, are dangerous enough to harm people, and are not easily decomposed, causing environmental pollution. Ceramics, including pottery, tile, etc., have greatly increased in production amounts according to expansion of their uses. When ceramics are wasted, their pieces are dangerous like glass pieces. Additionally, when ceramic pieces are buried in land, their decomposition requires at least 500 years. Accordingly, ceramic pieces are also one of environmental pollutants.

It is proposed to reuse such waste glass products as construction materials.

For example, Japanese Utility Model Laid-Open Publication No.53-20253 discloses that waste glass pieces are made round so that they can be used as a concrete block aggregate and as a cement material.

Japanese Pat. Laid-Open Publication No. 2000-272959 states a crystalline glass ceramic composite for construction use, which comprises waste glass, waste Portland cement material, and ash of silica plant such as rice husk and is obtained by sintering these materials at 800-1,100° C. to produce β-wollastonite crystals in the glass and mixing glass or ceramic powders with the crystals being used as a binder. Resulting from the recycling of such wastes, the ceramic composite can be produced at low price, and shows high solid phase reactivity without requiring high heat energy. However, the crystalline glass ceramic composite cannot be reused.

Japanese Pat. Laid-Open Publication No. 10-53443 suggests a glass material suitable for use in cement or asphalt, which is prepared by pulverizing pieces of waste glass into glass powder, hardening the glass powder in a heater, and thermally fusing the glass powder with a powder mixture of ceramic or silicon and inorganic oxides. Japanese Pat. Laid-Open Publication No. 11-21640 discloses a metal concrete composition obtained by filling a suitable amount of an admixture of natural rock pieces, minerals, waste glass and ceramic pieces in a metal or alloy matrix.

Korean Pat. Laid-Open Publication No. 2001-100500 discloses a heat-insulating panel for prefabrication, recycled from waste resins, rock wools, and glass fibers, and a method and apparatus for producing the same.

Concrete substitute products developed thus far, however, are inferior to the concrete composition obtained from an admixture of flyash and slag according to the present invention in physical properties. Particularly, when waste glass or ceramic is reused, the substitutes leave much to be desired.

For example, concrete compositions based on synthetic resins do not guarantee dimensional stability when it is applied for the construction of structures thicker than 20 mm. A dimension stability trouble is also found in the course of cooling processes during which flexion occurs in the products. Additionally, because UV light penetrates into conventional synthetic resin-based concrete compositions, they are easily oxidized, undergoing a durability decrease. Sometimes, their high flexibility may be an obstacle where inflexibility is needed. When flame-resistant products are prepared from the synthetic resin-based compositions, the amount of a flame retardant is dependent upon that of the synthetic resins used. Therefore, a high content of synthetic resins requires a large amount of a flame retardant, increasing the production cost. In the case that flyash is used in admixture with synthetic resins, it is impossible to dye the finally obtained products with any color but black because flyash from thermoelectric power plants is not completely burned one. Moreover, when compositions with incompletely combusted coal components is required to have inflammability, excess flame retardant is needed, giving rise to an increase of the production cost. Conventional products with flyash are so light, with specific gravity ranging from 1.2 to 1.4, that they cannot be used for the construction of embankment blocks or artificial fishing reefs which require a specific gravity of 1.6 or greater.

### SUMMARY OF THE INVENTION

Therefore, it is an object of the present invention to overcome the above problems encountered in prior arts and to provide a GRC composition which can be prepared through reuse of waste resources, such as waste thermoplastic synthetic resins, waste glass, and waste ceramics, in addition to being superior in tensile strength, bending strength and durability to conventional concrete compositions obtained from admixtures of flyash and slag, thereby preventing environmental pollution.

It is another object of the present invention to provide a method of producing such a GRC composition.

In accordance with one aspect of the present invention, there is provided a glass resin ceramic composition, comprising: 10-50% by weight of a waste thermoplastic resin; and 50-90% by weight of waste ceramic and/or waste glass ranging, in average diameter, from 10 to 40 μm.

In accordance with another aspect of the present invention, there is provided a method of producing a glass resin ceramic composition, comprising the steps of: regenerating waste thermoplastic synthetic resins through a melt-recycling process, a pulverizing process, and a thermal pressing process; melting 10-50% by weight of the waste thermoplastic resins, together with 50-90% by weight of waste ceramic and/or glass particles ranging, in average size, from 10 to 40 μm, at 200-230° C. in a formulating apparatus equipped with a melting screw and storing the resulting formulation in a reservoir while removing gas or vapor through an open hole; and injecting the formulation into a desirable mold and circulating cooling water maintained at 5-15° C. through internal cooling lines of the mold.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a photograph showing a GRC specimen prepared in accordance with the present invention, in a perspective view; and

FIG. 2 is a photograph showing a specimen made of waste synthetic resins only, in a perspective view.

### DETAILED DESCRIPTION OF THE INVENTION

The term “GRC composition” as used in the invention means a composition comprising waste glass, waste resin and waste ceramic.

The present invention pertains to a GRC composition comprising 10-50% by weight of a waste thermoplastic resin; and 50-90% by weight of waste ceramic and/or waste glass ranging, in average diameter, from 10 to 40 μm.

Waste thermoplastic resins used in the present invention can be obtained from waste plastic products for universal purposes, made of polypropylene, polyethylene, polystyrene or copolymers thereof. They can be easily found in wastes from usual articles, for example, agricultural vinyl products, household synthetic resin products, electric lines, synthetic resins used in automobiles, etc. For reuse of the waste synthetic resins, melt-regenerating, pulverizing and thermal pressurizing processes may be executed. It is preferable that the GRC composition according to the present invention comprised the waste thermoplastic resin at an amount of 10-50% by weight. For example, if the amount of the waste thermoplastic resin is below 10% by weight, tensile strength and flexural strength are deteriorated. On the other hand, if the waste thermoplastic resin is used at an amount of more than 50% by weight, an improvement is found in tensile strength whereas a decrease occurs in compression strength and flexural strength.

Usually, waste synthetic resins can be simply recycled through melt-regenerating, pulverizing and thermal pressurizing processes. In a melt-regenerating process, waste a synthetic resin is melted in a screw cylinder heated to 200-230° C. and, when the molten mass is allowed to go through the head, the resulting noodle-like resin material is cut into chips 3-5 mm long. Then, the chips are pulverized. In the pulverizing process, thick synthetic resin products, after being washed, are cut into sizes of φ5 mm-15 mm. In the thermal pressuring process, scraps such as waste vinyl products are heated to 80-150° C. and then, forced to go through a hole of φ10 mm by use of an oil cylinder under press.

Waste ceramics available in the present invention are not specifically limited, but are wastes of general ceramic products comprising waste potteries, tiles, stools, etc. Almost all glass products, including waste glass bottles and waste glass plates, can be used in the present invention. Either waste ceramic or waste glass may be used in the present invention, but preferable is an admixture of waste ceramic and glass. The relative amount between them is not specifically limited.

Preferably, waste ceramic and waste glass pieces have an average diameter of 10-40 μm in accordance with the present invention. For example, waste ceramic and/or glass pieces with an average size less than 10 μm are not easily mixed with waste synthetic resins. On the other hand, if their size is over 40 μm, the mechanical apparatuses used undergo severe abrasion.

In accordance with the present invention, a flame retardant selected from the group consisting of decabrome, DE-83R and FR-1210 may be added at an amount of 0.1-20% by weight of the GRC composition. Further, antimony trioxide may be added as a dispersant to aid the diffusion of the flame retardant at an amount of 0.1-10% by weight of the GRC composition. Aluminum hydroxide, as a further flame retardant, may be used at an amount of 0.1-40% by weight of the waste synthetic resin. When too much flame retardants are used, the composition is improved in flame retardancy, but is economically unfavorable. On the other hand, necessary flame retardancy cannot be obtained with less than the minimal content of the flame retardants.

Desired colors can be developed in the GRC composition of the present invention by use of commercially available pigments for synthetic resins at an amount of 0.001-0.3% by weight of the synthetic resin, according to the kind and intensity of the colors.

Hereinafter, a detailed description will be given of a production method of the GRC composition according to the present invention. Waste thermoplastic resins are regenerated through a melt-regenerating process, a pulverizing process, and a thermal pressurizing process, as described above.

An admixture comprising 10-50% by weight of the regenerated thermoplastic resin; and 50-90% by weight of waste ceramic and/or waste glass pieces with an average size of 10-40 μm is melted at 200-230° C. in a formulator equipped with a melting screw while gas and vapor are removed through an open hopper. The resulting formulation is stored in a reservoir. Particular attention must be paid to temperature control upon melting. For example, application of too large heat results in the decomposition of the synthetic resin into low-molecular weight saturated and unsaturated hydrocarbons, such as ethylene (C₂H₄), ethane (C₂H₆), propylene (C₃H₆) , propane (C₃H₈) , butane (C₄H₁₀) . Suitable for formulation melting process is a temperature range from 200 to 230° C.

Thereafter, the stored formulation is injected into a mold under a low pressure, after which cooling water maintained at 5-15° C. is circulated through internal cooling lines of the mold. The pressure generally ranges from 10 to 40 kg/cm², depending on the strength necessary to the final product. If the pressurization ceases before the temperature of the product falls below about 70° C. , the obtained products are not desirable ones or have insufficient strength. When the cooling temperature is below 5° C., the products suffer from high breakage percentage. On the other hand, a cooling temperature higher than 15° C. results in a decrease in productivity.

The GRC composition prepared in accordance with the present invention has better tensile and bending strength than usual concrete compositions and conventional PAS compositions. Additionally, the GRC composition does not allow UV light to penetrate thereinto, so that its durability outlasts that of usual concrete compositions or conventional PAS compositions. Furthermore, the GRC composition of the present invention is lighter than conventional cement concrete whose specific gravity is in the range of 2.2-2.4, but heavier than PAS concrete composition whose specific gravity is in the range of 1.2-1.6. Therefore, the GRC composition can be used in a variety of fields, including embankment blocks and artificial fishing reefs. Although the flame retardants differ from one to another in flame-retardation efficient amount, better flame retardancy can be obtained in the GRC composition of the present invention by use of much less flame retardants than in conventional compositions. Accordingly, the GRC composition is economically favorable. Moreover, the GRC composition of the present invention utilizes wastes of polyethylene and polypropylene, waste glass and waste ceramics, which produce serious industrial pollution, so that the present invention contributes to pollution settlement and resource reuse. Also, the GRC composition can be recycled. In addition, the GRC composition of the present invention shows excellent dimensional stability, thereby uniformly maintaining product quality. In contrast to concrete compositions comprising flyash, the GRC composition enjoys the advantage of being tinged with desired colors.

Having generally described this invention, a further understanding can be obtained by reference to certain specific examples which are provided herein for purposes of illustration only and are not intended to be limiting unless otherwise specified.

### EXAMPLE 1

Waste thermoplastic resins (PE, PP) were regenerated through a melting process, a pulverizing process and a thermal pressing process. Separately, waste ceramics and waste glass were collected, washed and broken into pieces with an average size of 30 μm. An admixture comprising 50% by weight of the waste thermoplastic resin, 10% by weight of the waste ceramic, and 40% by weight of the ceramic glass was melted at 230° C. in a formulator equipped with a melting screw while gas and vapor were removed through an open hopper. The resulting formulation was stored in a reservoir. Thereafter, the stored formulation was injected into a mold under a low pressure, after which cooling water maintained at 10° C. was circulated through internal cooling lines of the mold to obtain GRC composition specimens. They were measured for tensile strength, bending strength, impact strength, specific gravity, and load deformation temperature and the results are given in Table 1, below.

### EXAMPLES 2 AND 3

GRC composition specimens were prepared in a manner similar to that of Example 1, except that GRC composition components were used as shown in Table 1. The analysis results of them are given in Table 1, below.

### COMPARATIVE EXAMPLES 1 AND 2

Conventional PAS composition specimens were prepared in a manner similar to that of Example 1, except that PAS composition components were used as shown in Table 1. The analysis results of them are given in Table 1, below.

TABLE 1

| | Ex. 1 | Ex. 2 | Ex. 3 | C. Ex. 1 | C. Ex. 2 |
|---|---|---|---|---|---|
| Waste Synthetic | 50 | 40 | 30 | 50 | 50 |
| Resin (wt %) | | | | | |
| Waste Glass (wt %) | 40 | 40 | 40 | | |
| Waste Ceramic | 10 | 20 | 30 | | |
| (wt %) | | | | | |
| Flyash (wt %) | | | | 50 | 25 |
| Furnace Slag (wt %) | | | | | 25 |
| Specific Viscosity | 1.61 | 1.76 | 1.82 | 1.30 | 1.39 |
| KSM 3016 90 | | | | | |
| Tensile | 236 | 215 | 189 | 208 | 193 |
| Strength (kg/cm²) | | | | | |
| KSM 3006 | | | | | |
| Bending | 310 | 318 | 308 | 298 | 278.6 |
| Strength (kg/cm²) | | | | | |
| KSM 3015 | | | | | |
| Thermal Expansion | 8.5 × 10⁻⁵ | 8.5 × 10⁻⁵ | 8.1 × 10⁻⁵ | 8.8 × 10⁻⁵ | 9.1 × 10⁻⁵ |
| Coeffi. | | | | | |
| KSM 3015 | | | | | |
| Load Deformation | 90° C. | 89.5° C. | 91° C. | 90.3° C. | 92° C. |
| Temp. | | | | | |
| KSM 3065 | | | | | |
| Impact | 2.9 | 2.8 | 2.6 | 3.0 | 1.7 |
| Strength (kg/cm²) | | | | | |
| KSM 3015 | | | | | |

As apparent from Table 1, comparison of data between Example 1 and Comparative Example 1, which both used the same amount of a synthetic resin, the GRC composition of the present invention was far superior in tensile strength and bending strength to the conventional composition. When they are applied in practice, such little difference between values makes a large difference in product quality.

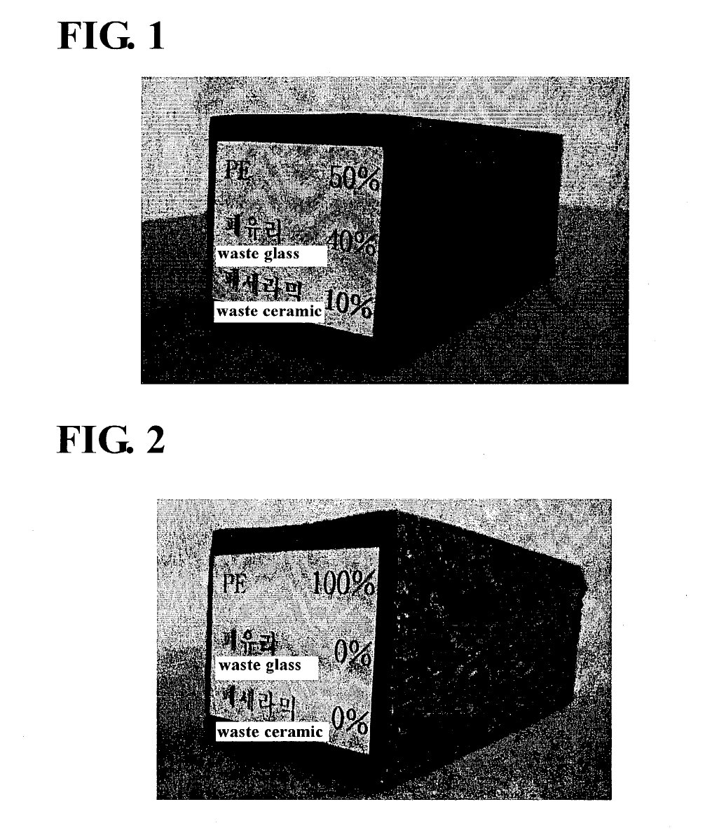

A specimen prepared according to Example 1 was photographed in a perspective view, as shown in FIG. 1. When compared with the specimen made of 100% of synthetic resin (FIG. 2), the specimen of FIG. 1 was not flexed at all and thus, found to be of much better dimensional stability than the specimen of FIG. 2, as observed with naked eye. Also, the specimens of Examples are equal or superior in impact strength to those of Comparative Examples.

### EXAMPLES 4 TO 6

GRC composition specimens were prepared in a manner similar to that of Example 1, except that GRC composition components were used as shown in Table 2. The GRC composition specimens were measured for flame retardancy, tensile strength and bending strength, and the results are given in Table 2, below.

As for flame retardancy, it was tested in accordance with the U.S.A. flame retardancy test protocol ‘UL-94 at 3.2 mm’. The descending order of flame retardancy is ‘V0’, ‘V1’, ‘V2’ and ‘fail’

### COMPARATIVE EXAMPLES 3 AND 4

Conventional PAS composition specimens were prepared in a manner similar to that of Example 1, except that PAS composition components were used as shown in Table 2. The PAS composition specimens were measured for flame retardancy, tensile strength and bending strength, and the results are given in Table 2, below.

TABLE 2

| | Ex. 4 | Ex. 5 | Ex. 6 | C. Ex. 3 | C. Ex. 4 |
|---|---|---|---|---|---|
| LDPE (wt %) | 50 | 50 | 40 | 50 | 40 |
| Decabrome (wt %) | 5 | 10 | 10 | 10 | 10 |
| Sb₂O₃ (wt %) | 2.5 | 5 | 5 | 5 | 5 |
| Waste | 32.5 | 25 | 35 | | |
| Glass (wt %) | | | | | |
| Waste | 10 | 10 | 10 | | |
| Ceramic (wt %) | | | | | |
| Flyash (wt %) | | | | 25 | 35 |
| Furnace | | | | 10 | 10 |
| Slag (wt %) | | | | 10 | 10 |
| UL-94 at 3.2 mm | V2 | V1 | V0 | V2 | V1 |
| Tensile | 236 | 236 | 215 | 208 | 193 |
| Strength (kg/cm²) | | | | | |
| KSM 3006 | | | | | |
| Bending | 310 | 310 | 318 | 298 | 278.6 |
| Strength (kg/cm²) | | | | | |
| ESM 3015 | | | | | |

Although the same amount of decabrome (flame retardant) was used, the GRC composition of Example 5 is superior in flame retardancy to that of Example 5, as recognized from Table 2. It was also found that no change occurred in strength even if content of decabrome was allowed to be increased while decreasing the amount of waste glass.

### EXAMPLES 7 TO 10

GRC composition specimens were prepared in a manner similar to that of Example 1, except that GRC composition components were used as shown in Tables 3 and 4, below. The GRC composition specimens were measured for flame retardancy, and the results are given in Tables 3 and 4.

### COMPARATIVE EXAMPLES 5 AND 6

Conventional PAS composition specimens were prepared in a manner similar to that of Example 1, except that PAS composition components were used as shown in Tables 3 and 4, below. The PAS composition specimens were measured for flame retardancy, and the results are given in Tables 3 and 4.

TABLE 3

| | Ex. 7 | Ex. 8 | C. Ex. 5 |
|---|---|---|---|
| HDPE (wt %) | 50 | 50 | 50 |
| Decabrome (wt %) | 5 | 10 | 10 |
| Sb₂O₃ (wt %) | 2.5 | 5 | 5 |
| Waste | 32.5 | 25 | |
| Glass (wt %) | | | |
| Waste Ceramic | 10 | 10 | |
| (wt %) | | | |
| Flyash (wt %) | | | 25 |
| Furnace Slag | | | 10 |
| UL-94 at 3.2 mm | V2 | V0 | V2 |

TABLE 4

| | Ex. 9 | Ex. 10 | C. Ex. 6 |
|---|---|---|---|
| PP (wt %) | 50 | 50 | 50 |
| Decabrome (wt %) | 5 | 10 | 10 |
| Sb₂O₃ (wt %) | 2.5 | 5 | 5 |
| Waste | 32.5 | 25 | |
| Glass (wt %) | | | |
| Waste | 10 | 10 | |
| Ceramic (wt %) | | | |
| Flyash | | | 25 |
| Furnace Slag | | | 10 |
| UL-94 at 3.2 mm | V1 | V0 | V2 |

It is apparent from Tables 3 and 4 that, when the same amount of decabrome (flame retardant) is used, the compositions of Examples 8 and 10 show higher flame retardancy than do those of Comparative Examples 5 and 6.

The GRC compositions according to the present invention, as described hereinbefore, have higher tensile strength, bending strength and durability than do the conventional concrete compositions obtained from an admixture of flyash and slag. Also, the GRC compositions of the present invention show high dimensional stability such that, when they are used to construct large-size products, uniform quality is guaranteed. Thanks to their high specific gravity, the GRC compositions of the present invention can be applied for the production of the products which need a considerable weight. Further, desired colors can be expressed in the compositions. Reuse of waste ceramics and glass will give contribution to settlement of environmental pollution.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A glass resin ceramic composition, comprising:
10-50% by weight of a waste thermoplastic resin; and
50-90% by weight of waste ceramic and/or waste glass ranging, in average diameter, from 10 to 40 μm.

2. The glass resin ceramic composition as set forth in claim 1, further comprising a flame retardant at an amount of 0.1-20% by weight based on the weight of the waste synthetic resin, said flame retardant being selected from among bromic compounds; and antimony trioxide at an amount of 0.1-10% by weight of the waste synthetic resin, said antimony trioxide functioning to aid the diffusion of the flame retardant.

3. The glass resin ceramic composition as set forth in claim 1, further comprising aluminum hydroxide at an amount of 0.1-40% by weight based on the weight of the waste synthetic resin, said aluminum hydroxide functioning as a flame retardant.

4. The glass resin ceramic composition as set forth in claim 1, wherein said waste ceramic comprises waste potteries, waste tiles, waste ceramic stools, or mixtures thereof.

5. The glass resin ceramic composition as set forth in clam 1, wherein said waste glass comprises waste glass bottles, waste glass plates, or mixtures thereof.

6. A method of producing a glass resin ceramic composition, comprising the steps of:
regenerating waste thermoplastic synthetic resins through a melt-recycling process, a pulverizing process, and a thermal pressing process;
melting 10-50% by weight of the waste thermoplastic resins, together with 50-90% by weight of waste ceramic and/or glass particles ranging, in average size, from 10 to 40 μm, at 200-230° C. in a formulating apparatus equipped with a melting screw and storing the resulting formulation in a reservoir while removing gas or vapor through an open hole; and
injecting the formulation into a desirable mold and circulating cooling water maintained at 5-15° C. through internal cooling lines of the mold.

7. The method as set forth in claim 6, further comprising the step of adding a bromic flame retardant at an amount of 0.1-20% by weight based on the weight of the waste synthetic resin, and antimony trioxide at an amount of 0.1-20% by weight based on the weight of the waste synthetic resin, said antimony trioxide functioning to aid the diffusion of the flame retardant in the composition.

8. The method as set forth in claim 6, wherein the glass resin ceramic composition further comprises aluminum trioxide at an amount of 0.1-40% by weight based on the weight of the waste synthetic resin, said aluminum trioxide acting as a flame retardant.
